(19) United States
(12) Patent Application Publication
(10) Pub. No.: US 2026/0093514 A1
(43) Pub. Date: Apr. 2, 2026

(54) System And Method For Organizational Governance Enforced By Advanced Links In Cloud Environments

(71) Applicant: Oracle International Corporation, Redwood Shores, CA (US)

(72) Inventors: John M. Lien, Ashburn, VA (US); Hayk Ghazaryan, Bellevue, WA (US); Zhiyu Du, Woodinville, WA (US); Dominic Francis Varakukala, San Jose, CA (US); Lisha Mohan, Seattle, WA (US); Harsha Hardhagari, Seattle, WA (US); Jonathan Cardenas Garcia, Guadalajara (MX)

(73) Assignee: Oracle International Corporation, Redwood Shores, CA (US)

(21) Appl. No.: 18/901,553

(22) Filed: Sep. 30, 2024

(51) Int. Cl. G06F 9/455

(52) U.S. Cl. CPC G06F 9/45558; G06F 2009/45562; G06F 2009/45575; G06F 2009/45587

(57) ABSTRACT

Techniques for enabling a service to perform operations corresponding to a subject tenancy on behalf of a governing tenancy are disclosed. The system receives a request from a service for a resource principal token. The request includes a resource principal, a service identifier for the service, and a link identifier that identifies a governance link. The governance link is associated with a governing tenancy, a subject tenancy, and a service. The system evaluates the governance link to determine if the governance link is active. After determining that the governance link is active, the system responds to the request from the service, providing a resource principal token. The resource principal token that is provided to the service forms a basis for authorizing the service to perform operations corresponding to the subject tenancy on behalf of the governing tenancy.

### TECHNICAL FIELD

The present disclosure relates to systems and methods for use by tenants of a cloud infrastructure environment in performing governance-related operations. In particular, the present disclosure relates to the onboarding and use of services within a cloud infrastructure environment.

### BACKGROUND

A cloud computing environment can be used to provide access to a range of complementary cloud-based components, such as software applications or services, that enable organizations or enterprise customers to operate their applications and services in a highly available hosted environment.

The benefits to an organization in moving their application and service needs to a cloud environment include a reduction in the cost and complexity of designing, building, operating, and maintaining their own on-premise data center, software application framework, or other information technology infrastructure. Access to resources in a cloud environment may be restricted using a variety of mechanisms.

In some cloud environments, the concept of governing (parent) tenancies and subject (child) tenancies is implemented to facilitate efficient resource management and policy enforcement. The governing tenancy can create and/or manage multiple subject tenancies, each with its own isolated set of resources, users, and policies. This hierarchical structure allows the governing tenancy to apply overarching policies and configurations that propagate down to the subject tenancies, ensuring consistent governance and compliance across the organization. Subject tenancies can be administered independently, but their configuration and access permissions are often subject to the control of a governing tenancy. This setup enables centralized management while allowing for delegation of administrative responsibilities. The governing tenancy can enforce quotas, monitor resource usage, and audit activities across subject tenancies, providing a unified view of the cloud environment.

Several factors influence the design and implementation of cross-tenancy operations. These factors include the architectural design of the system, the security requirements of each tenant, the legal and regulatory frameworks governing data access and privacy, and the technical capabilities of the authorization mechanisms employed. The interaction between these factors determines the feasibility and security efficacy of cross-tenancy operations, making it necessary to tailor solutions to the specific contexts of the tenants involved.

In some implementations, governing tenancies have influence over the services made available to the subject tenancies. The governing tenancy can define the services and resources that are accessible to each subject tenancy. This is achieved through configurations at the governing level and can restrict or grant access to specific services and resources for the subject tenancies. Additionally, the governing tenancy may enforce service limits and usage caps to control the consumption of resources by the subject tenancies, ensuring alignment with organizational policies and budget constraints. The governing tenancy's control over service availability and configuration helps maintain consistency and security across the cloud environment.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6 illustrates governance link architecture in accordance with one or more embodiments;

FIG. 7 illustrates an example set of operations for the use of governance links in accordance with one or more embodiments; and FIG. 8 illustrates an example set of operations for the creation and use of governance links in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CLOUD COMPUTING TECHNOLOGY
3. COMPUTER SYSTEM
4. GOVERNANCE LINK MANAGEMENT ARCHITECTURE
5. GOVERNANCE LINK CREATION AND USE
6. EXAMPLE EMBODIMENT
7. MISCELLANEOUS; EXTENSIONS

### 1. General Overview

One or more embodiments enable a service to perform operations associated with a subject tenancy on behalf of a governing tenancy. Enabling the service occurs in response to confirming the existence of an active governance link between the governing tenancy and the subject tenancy, the governance link referencing the service. Enabling the service includes issuing a resource principal token that forms the basis for authorizing the service to perform operations associated with the subject tenancy.

The system receives a request from a service for a resource principal token. The request includes a resource principal, a service identifier for the service, and a link identifier that identifies a governance link. The governance link is associated with a governing (parent) tenancy and a subject (child) tenancy. The system evaluates the governance link to determine if the governance link is active. After determining that the governance link is active, the system responds to the request from the service, providing a resource principal token. The resource principal token that is provided to the service forms a basis for authorizing the service to perform operations corresponding to the subject tenancy on behalf of the governing tenancy.

One or more embodiments described in this Specification and/or recited in the claims may not be included in this General Overview section.

### 2. Cloud Computing Technology

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components; example services include billing software, monitoring software, logging software, load balancing software, clustering software, etc. Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and install enterprise software into that VM. Customers can then use the provider's services to perform various functions, including balancing network traffic, troubleshooting application issues, monitoring performance, and managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling (OS), middleware, and/or application deployment, such as on self-service virtual machines. The self-service virtual machines can be spun up on demand.

In some examples, IaaS provisioning may refer to acquiring computers or virtual hosts for use, even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on one another, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually, and/or using a provisioning tool) prior to deployment of code to be executed on the infrastructure. However, in some examples, the infrastructure that will deploy the code may first be set up. In some instances, the provisioning can be done manually, a provisioning tool may be utilized to provision the resources, and/or deployment tools may be utilized to deploy the code once the infrastructure is provisioned.

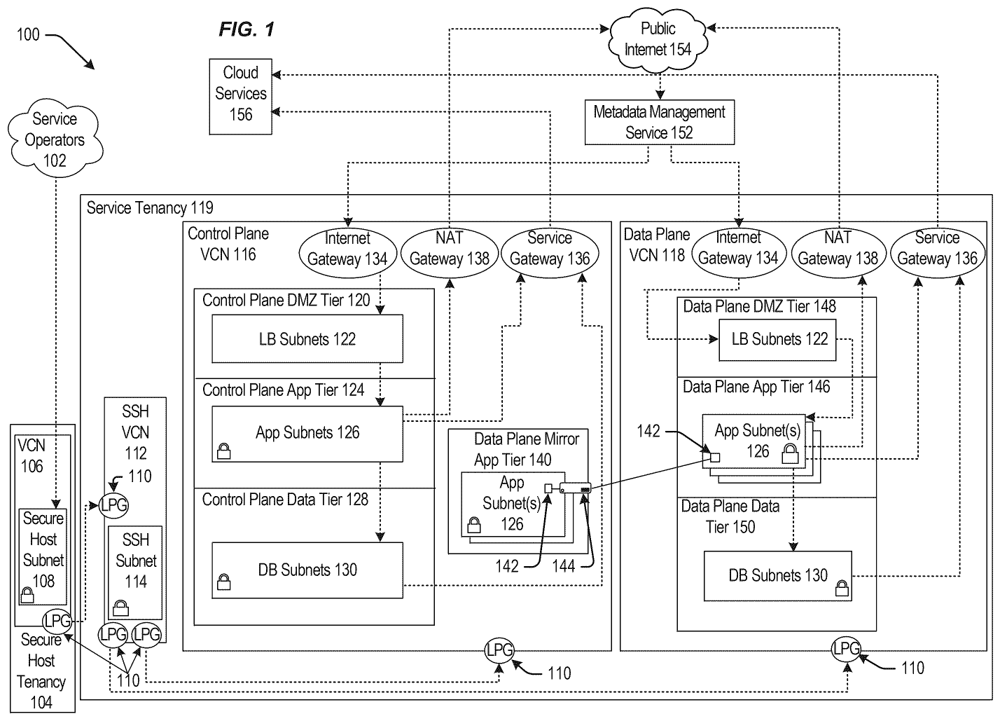

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, such as portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, including personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems such as Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116. The app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way; the service gateway 136 can make API calls to cloud services 156, and cloud services 156 can send requested data to the service gateway 136. However, cloud services 156 may not initiate API calls to the service gateway 136.

In some examples, the secure host tenancy 104 can be directly connected to the service tenancy 119. The service tenancy 119 may otherwise be isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118. The control plane VCN 116 and the data plane VCN 118 may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154 for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119. The service tenancy 119 may be isolated from public Internet 154.

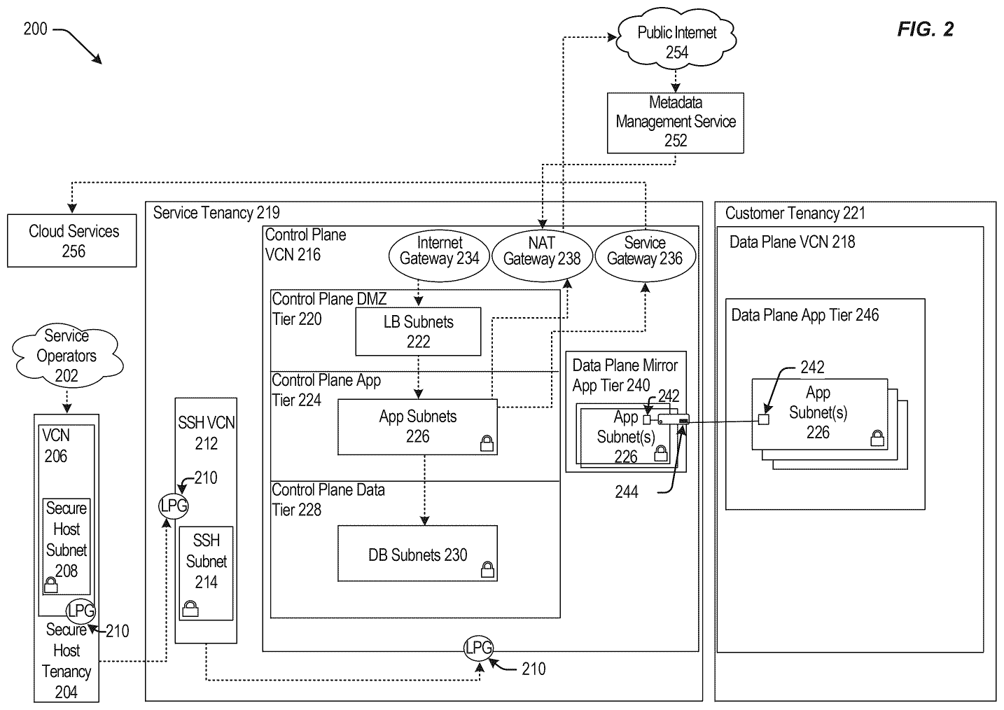

FIG. 2 is a block diagram illustrating another example pattern of an IaaS architecture 200 according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216. The app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique, compute instance 244 that is contained in the service tenancy 219. Each compute instance 244 may allow communication between the control plane VCN 216 contained in the service tenancy 219 and the data plane VCN 218 that is contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment or other usage of resources of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

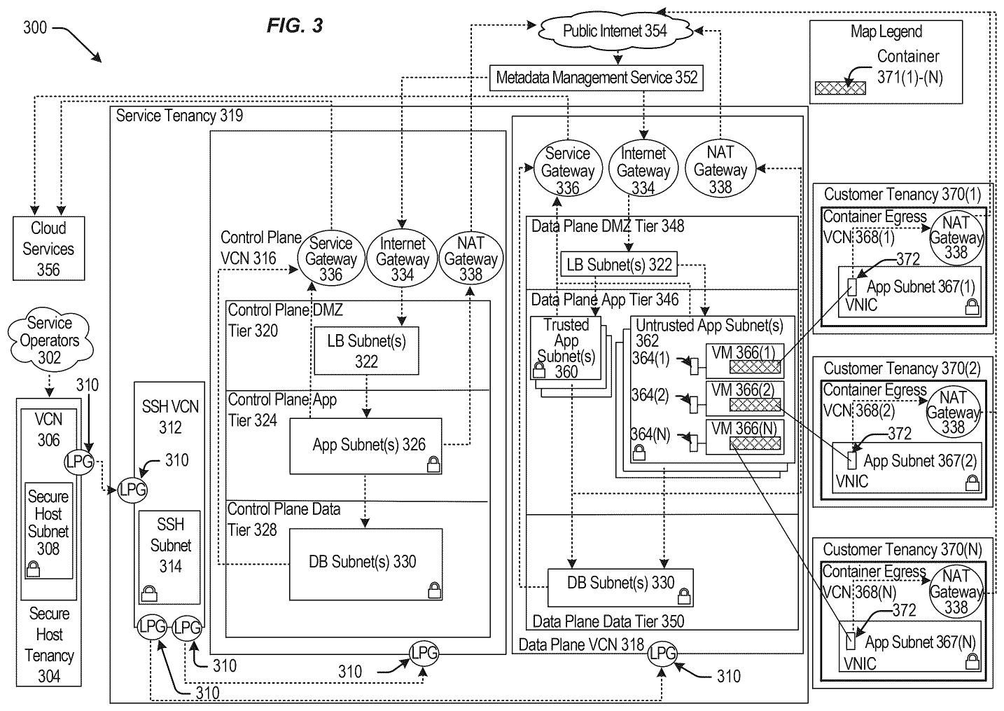

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360, untrusted app subnet(s) 362 of the data plane app tier 346, and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether or not to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 380. Respective containers 381(1)-(N) contained in the VMs 366(1)-(N) may be configured to run the code. In this case, there can be a dual isolation (e.g., the containers 381(1)-(N) running code), where the containers 381(1)-(N) may be contained in at least the VM 366(1)-(N) that are contained in the untrusted app subnet(s) 362) that may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of running the code, the IaaS provider may kill or otherwise dispose of the containers 381(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

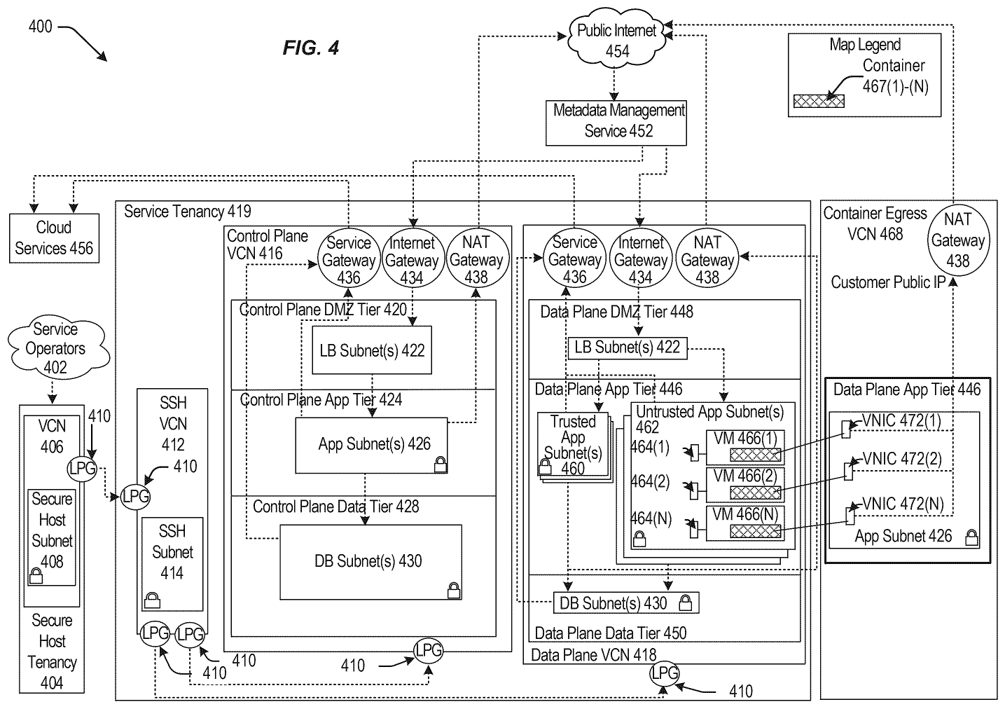

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that request a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, and 400 may include components that are different and/or additional to the components shown in the figures. Further, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited, to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource when the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, each database implemented by a multi-tenant computer network may be tagged with a tenant ID. A tenant associated with the corresponding tenant ID may access data of a particular database. As another example, each entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for each tenant, a set of applications that the tenant is authorized to access. For each application, a list of tenant IDs of tenants authorized to access the application is stored. A tenant is permitted access to a particular application when the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 3. Computer System

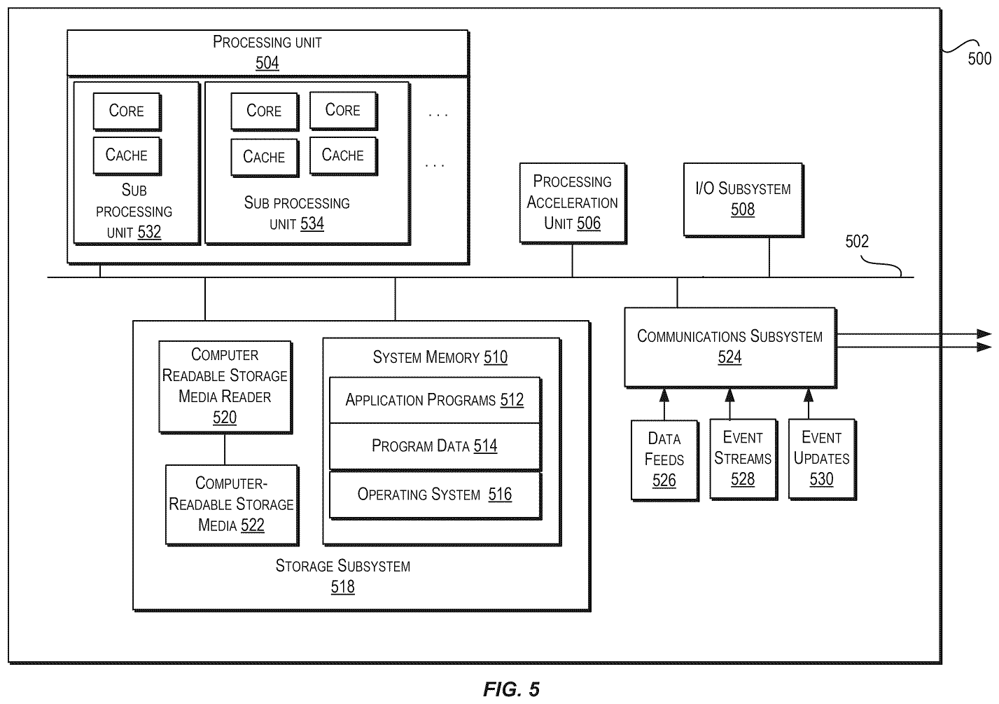

FIG. 5 illustrates an example computer system 500. An embodiment of the disclosure may be implemented upon the computer system 500. As shown in FIG. 5, computer system 500 includes a processing unit 504 that communicates with peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 to communicate with each other as intended. Although bus subsystem 502 is shown schematically as a single bus, alternative embodiments of the bus subsystem may utilize multiple buses. Bus subsystem 502 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the IEEE P1386.1 standard.

Processing unit 504 controls the operation of computer system 500. Processing unit 504 can be implemented as one or more integrated circuits (e.g., a conventional microprocessor or microcontroller). One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, the program code to be executed can be wholly or partially resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices such as computed tomography, magnetic resonance imaging, position emission tomography, or medical ultrasonography devices. User interface input devices may also include audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 500 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components, including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various programs may be loaded into system memory 510 including, but not limited to, client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500, including instructions executable by processing unit 504 of computer system 500.

Computer-readable storage media 522 can include any appropriate media known or used in the art, including storage media and communication media, such as but not limited to volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory, such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components to access wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services, such as Twitter® feeds, Facebook® updates, web feeds such as Rich Site Summary (RSS) feeds, and/or real-time updates from one or more third party information sources.

Additionally, communications subsystem 524 may be configured to receive data in the form of continuous data streams. The continuous data streams may include event streams 528 of real-time events and/or event updates 530 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended as a non-limiting example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. Governance Link Management Architecture

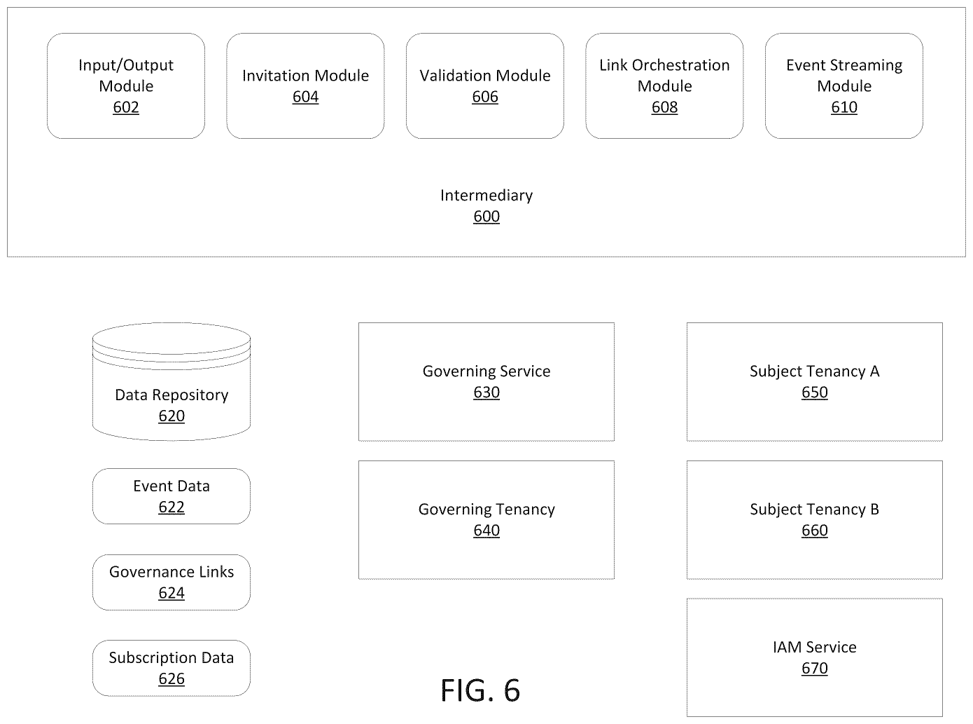

FIG. 6 illustrates governance link architecture in accordance with one or more embodiments. As illustrated in FIG. 6, intermediary 600 includes input/output module 602, invitation module 604, validation module 606, link orchestration module 608, and event streaming module 610. FIG. 6 further illustrates a data repository 620 that includes event data 622, governance links 624, and subscription data 626. FIG. 6 further illustrates governing service 630, governing tenancy 640, subject tenancy A 650, and subject tenancy B 660. In one or more embodiments, the system 600 may include more or fewer components than the components illustrated in FIG. 6. The components illustrated in FIG. 6 may be local to or remote from each other. The components illustrated in FIG. 6 may be implemented in software and/or hardware. Each component may be distributed over multiple applications and/or machines. Multiple components may be combined into one application and/or machine. Operations described with respect to one component may instead be performed by another component.

In accordance with one or more embodiments, input/output module 602 is configured to manage data integrity and quality as it enters intermediary 600 by incorporating initial checks and validations. These checks and validations ensure that incoming data meet predefined quality standards, like checking for missing values, ensuring consistency in data formats, and verifying data ranges and types. In accordance with one or more embodiments, input/output module 602 is configured to handle the distribution and exportation of outputs for consumption by other modules, systems, or users. For example, input/output module 602 may be configured to format outputs into user-friendly and accessible formats, such as reports, visualizations, or data files, that are compatible with other systems. Input/output module 602 also ensures secure and efficient transmission of these outputs to end-users or other systems in an embodiment and may employ encryption and secure data transfer protocols to maintain data confidentiality.

In accordance with one or more embodiments, invitation module 604 is configured to process invitations and invitation responses. The invitations and responses may include proxy invitations and responses that are sent by one system on behalf of another system. The invitation module 604 is responsible for managing invitations and responses across different systems. It initializes by establishing connections to relevant databases and external services through APIs. The module generates unique invitation identifiers that may have an expiration period. It stores the invitation identifiers along with associated metadata in a database such as data repository 620. When an invitation is created, the module formats and sends an invitation message via configured communication channels.

In accordance with one or more embodiments, the invitation module 604 receives invitations and proxy invitations from other systems, such as governing service 630, that are meant for a system other than intermediary 600. For example, the invitation module 604 may receive a proxy invitation from governing service 630 that is sent on behalf of governing tenancy 640. The invitation may be meant for subject tenancy A 650. In an embodiment, the invitation may be interpreted by invitation module 604 to determine the required destination for the invitation. For example, invitation module may determine based on subscription data 626 that governing tenancy 640, subject tenancy A 650, and subject tenancy B 660 share a product subscription, so the invitation module 604 may infer that the invitation should be sent to both subject tenancy A 650 and subject tenancy B 660.

In accordance with one or more embodiments, invitation module 604 employs a listener to listen for invitations and responses to invitations. Upon receiving a response, invitation module 604 triggers any configured workflows or actions, such as notifying other system components, including link orchestration module 608. Invitation module 604 supports configurable retry mechanisms for failed message deliveries and maintains logs for operations, facilitating monitoring and debugging.

In accordance with one or more embodiments, configuration settings for invitation module 604 include parameters for token expiration, message templates, communication channels, and database connections. The invitation module 604 provides an API for external systems to interact with intermediary 600, allowing for the creation, retrieval, and management of invitations. It is built with scalability in mind, utilizing asynchronous processing and load balancing to handle high volumes of invitations and responses. Error handling and exception management are integrated to ensure robustness and reliability.

In accordance with one or more embodiments, validation module 606 is configured to determine if a link is present between a governing tenancy and a subject tenancy. For example, a governing service may make a request for a resource principal token to perform an operation corresponding to a subject tenancy on behalf of a governing tenancy. If validation module 606 determines that there is no active link between the governing tenancy and the subject tenancy, the request is denied. If validation module 606 determines that there is an active link between the governing tenancy and the subject tenancy, validation module 606 may issue a resource principal token to the requesting governing service.

In accordance with one or more embodiments, a resource principal refers to a specific resource within a cloud environment that can act as an identity to perform actions or access other resources. This allows the resource itself, such as a virtual machine, a service, a storage bucket, or a database, to have permissions and perform operations autonomously, similar to how a user or service account operates. A resource principal token is a type of security token that represents the identity of the resource principal. This token is used to authenticate and authorize the resource principal to perform actions or access other resources within the cloud environment. The resource principal token contains information about the resource principal's identity and its permissions, ensuring that the resource can securely interact with other services and resources according to its defined policies. The resource principal token forms a basis for authorizing the service to take actions within the subject tenancy. In an embodiment, the resource principal token is associated with a feature that is identified in the link data for the active link. In accordance with one or more embodiments, the resource principal token is provided to the requesting governing service. In an embodiment, the resource principal token is exchanged with IAM service 670 for a resource principal session token that may be used by the governing service to take action within the subject tenancy.

In accordance with one or more embodiments, validation module 606 is configured to obtain governance link information from governance links 624 in data repository 620. For example, a governance link may indicate if there is a governance link between the governing tenancy and the subject tenancy. In addition, a governance link stored in governance links 624 indicates if a governance link is active or in another state, such as a deleting or deleted status.

In accordance with one or more embodiments, validation module 606 is configured to perform security checks to verify the authenticity of requests from governing tenancies. For example, validation module 606 may ensure that the governing service in the request is the same governing service associated with the governance link. In other embodiments, validation module 606 is configured with rules that require requests to come from the governing service associated with the feature identified in the request. In an embodiment, other validation rules may be applied by validation module 606, including rules related to subject tenancy validation.

In accordance with one or more embodiments, link orchestration module 608 is configured to create and maintain governance links. A governance link is a link between two tenancies indicating that there is a relationship between the tenancies. In an embodiment, link orchestration module 608 may create a governance link between a governing tenancy and a subject tenancy. A governing tenancy may be established, for example, to exercise control over one or more subject tenancies. The control may be related to policies, billing, resource allocation, compliance, security, efficient resource management, or any other form of control across associated tenancies. A subject tenancy operates under the governance of the governing tenancy, adhering to its policies while maintaining a degree of independence for specific projects, departments, or clients within the organization. This structure allows for centralized governance while enabling decentralized management, facilitating the effective distribution and oversight of resources within large-scale cloud environments.

In accordance with one or more embodiments, link orchestration module 608 stores governing links 624 in data repository 620. Governing links include mappings between tenancies in an embodiment. In accordance with one or more embodiments, governing links identify the governing tenancy, the subject tenancy, link status, and a governing service associated with the link, and governance features. In an embodiment, governing links identify one or more features of the governing service that is associated with the governing link. A governing link may be active, deleting, or deleted, and the governing link may be associated with a particular feature such as a security feature of a governing service available in a cloud computing environment.

In accordance with one or more embodiments, link orchestration module 608 is configured to communicate with invitation module 604. Invitation module 604 manages a governance link handshake process to ensure that assent is provided from authorized representatives or governing services for both the governing tenancy and the subject tenancy before a governance link is created. Invitation module 604 indicates to link orchestration module 608 when a handshake process is complete, triggering a governance link orchestration workflow. For example, intermediary 600 may receive a proxy request to generate a link from a governing service associated with a governing tenancy on behalf of the governing tenancy. The proxy request indicates assent on the part of the governing tenancy. Once invitation module 604 obtains approval from the subject tenancy operator or governing service, link orchestration module 608 creates a governance link between the governing tenancy and the subject tenancy.

In accordance with one or more embodiments, link orchestration module 608 is configured to facilitate the creation and deletion of governance links. For example, if an event occurs that results in a need to activate a governance link, link orchestration module 608 updates the governance link data associated with the governance link to reflect the active status. Likewise, if an event occurs that results in a need to delete a governance link, link orchestration module 608 updates the governance link data associated with the governance link to reflect the deleting or deleted status.

In accordance with one or more embodiments, event streaming module 610 detects the occurrence of real-time or near-real-time events and places them on a stream consumable by assorted services. Data related to the occurrence of events may also be stored as event data 622. The event streaming module 610 initializes by connecting to event sources that can include databases, message queues, or external APIs through configured adapters. These adapters monitor the event sources for specific triggers or changes, such as database updates, API calls, or messages in a queue.

In accordance with one or more embodiments, when an event is detected, the event streaming module 610 captures relevant data and metadata associated with the event. Data is then serialized into a structured format, such as JSON or Avro, ensuring compatibility with downstream consumers. The serialized event data is placed onto a streaming platform, such as Apache Kafka, AWS Kinesis, or Google Pub/Sub, where it becomes part of an event stream.

In accordance with one or more embodiments, the event streaming module 610 ensures that events are published to the stream in a fault-tolerant and scalable manner. It employs various mechanisms, such as batching, partitioning, and replicating to optimize performance and reliability. Batching aggregates multiple events before publishing, reducing the overhead of individual transmissions. Partitioning distributes events across multiple stream partitions, allowing parallel processing by consumers. Replicating ensures that events are duplicated across different nodes to prevent data loss in case of a failure.

In accordance with an embodiment, the event streaming module 610 provides an API for external governing services to subscribe to and consume events from the stream. These governing services can specify filters or criteria to receive only relevant events. The module supports different consumption models, including at-least-once and exactly-once delivery semantics, depending on the requirements of the consuming governing service.

In accordance with an embodiment, configuration settings for the module include parameters for event source connections, serialization formats, streaming platform details, and consumption models. The module maintains logs and metrics for operations, facilitating monitoring, debugging, and performance tuning. Error handling mechanisms are integrated to manage issues, such as connection failures, data serialization errors, and streaming platform outages. The event streaming module 610 design ensures high availability and scalability, enabling it to handle large volumes of events and deliver them efficiently to multiple consumers.

In accordance with one or more embodiments, governing service 630 represents a governing service that is registered with intermediary 600. Any governing service that a governing tenancy could use to manage resources associated with a subject tenancy may be represented by governing service 630. As an example, governing service 630 could be an Oracle Cloud Guard instance in one or more embodiments. In an embodiment, an operator associated with a governing tenancy may use an operator device (a computing device) to access and configure governing service 630. Governing service 630 is configured to use a resource principal to request a resource principal token that serves as the basis for authentication with one or more subject tenancies. For example, governing service 630 may continuously monitor log files associated with network or storage systems and other resources associated with a subject tenancy. Governing service 630 may also access configurations, activities, and security information. It may examine a wide range of resources, including compute instances, storage buckets, virtual cloud networks (VCNs), databases, and security groups. Governing service 630 may access resource configurations, network traffic logs, and system activities to generate billing reports, identify potential security risks, or perform other administrative or tenancy-management tasks. In accordance with one or more embodiments, the access afforded to governing service 630 is based on a resource principal token provided to governing service 630 by intermediary 600 in combination with policies stored on the relevant governing tenancies and subject tenancies by intermediary 600 in response to the creation of a governing link between the relevant governing tenancies and subject tenancies.

In one or more embodiments, data repository 620 is any type of storage unit and/or device (e.g., a file system, database, collection of tables, or any other storage mechanism) for storing data. Furthermore, data repository 620 may include multiple different storage units and/or devices. The multiple different storage units and/or devices may or may not be of the same type or located at the same physical site. Furthermore, data repository 620 may be implemented or executed on the same computing system as intermediary 600. Additionally, or alternatively, data repository 620 may be implemented or executed on a computing system separate from intermediary 600. The data repository 620 may be communicatively coupled to intermediary 600 via a direct connection or via a network.

In accordance with one or more embodiments, identity and access management (IAM) service 670 serves as a platform for managing identities and accessing privileges. This system is used to store, update, and manage access data that define the roles, permissions, and policies associated with operators and systems. Identity and access management system 670 is configured to perform verification operations to determine if services are authorized to perform operations.

In accordance with one or more embodiments, identity and access management system 670 incorporates authentication, authorization, and auditing mechanisms. Authentication processes are designed to confirm the identity of operators and systems by requiring them to present credentials that may include passwords, security tokens, or other verification methods. Following successful authentication, the authorization mechanism assesses if the access request aligns with the roles and permissions associated with the authentication information presented. For example, if a service presents a resource principal token, identity and access management system 670 verifies that the associated resource principal is authorized to access the requested resource, and if so, may provide a resource principal session token that provides temporary session-specific access rights. The identity management system's auditing features facilitate monitoring and logging access attempts and activities, providing a detailed record for security analysis and compliance auditing.

In accordance with one or more embodiments, identity and access management system 670 may integrate with other security and operational tools within the organization. For example, when integrating with directory services, identity and access management system 670 can automatically synchronize authorization and authentication data, ensuring that access rights are accurately reflected across the systems. Additionally, identity and access management system 670 may employ advanced security protocols and encryption standards to protect sensitive information and communications, further securing the authentication and authorization processes.

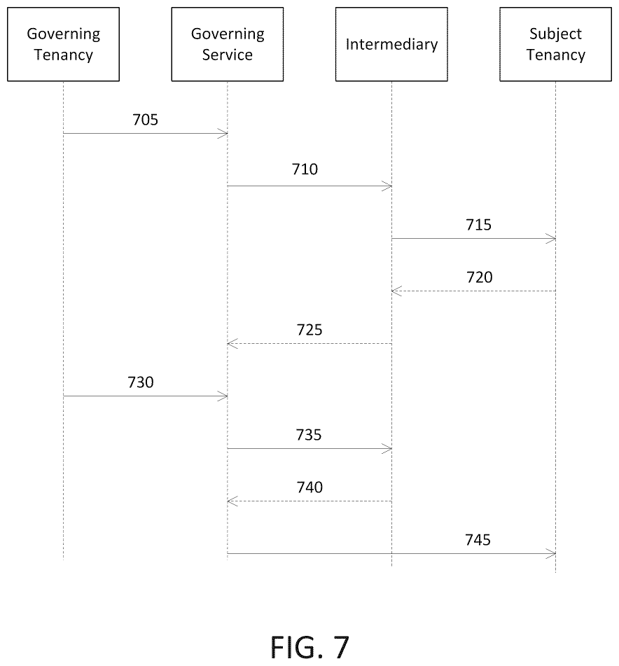

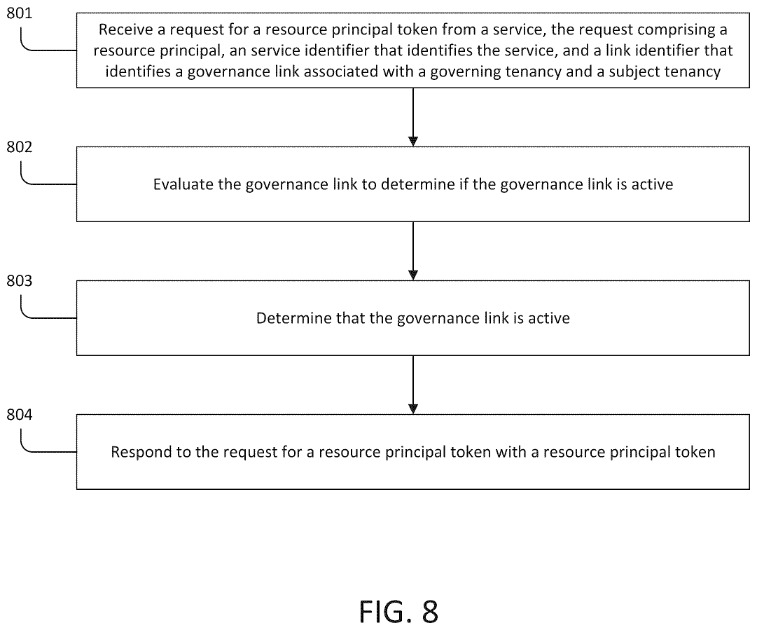

Information associated with intermediary 600 may be stored or implemented across any of components described in FIG. 6. However, this information is illustrated within the data repository 604 for purposes of clarity and explanation. In one or more embodiments, intermediary 600 refers to hardware and/or software configured to perform operations described herein for intermediary 600. Examples of operations for intermediary 600 are described below with reference to FIG. 7.

In an embodiment, intermediary 600 and other systems described herein are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, one or more systems described herein may include a user interface. A user interface refers to hardware and/or software configured to facilitate communications between a user and the corresponding system. A user interface renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of a user interface are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, the user interface is specified in one or more other languages, such as Java, C, or C++.

### 5. Governance Link Creation and Use

In accordance with one or more embodiments, a cloud service provider allows a variety of governing services to be available to its customers, such as security services and accounting services. The provider is responsible for evaluating each governing service to ensure it meets specific standards before making it accessible. This involves assessing security protocols, complying with relevant regulations, and performance metrics. The selection process includes performing risk assessments, vulnerability scans, and compliance checks. Some governing services may be provided by third-party vendors, while others may be developed and maintained by the service provider itself. Additionally, the provider reviews the governing service's integration capabilities and compatibility with existing infrastructure. This ensures that governing services adhere to the provider's operational requirements and maintain consistency across the platform.

In accordance with one or more embodiments, as part of the onboarding process, the cloud service provider receives documentation and other catalogue information to be made available to tenancy owners that may be interested in deploying the governing service. In addition, the cloud service provider receives a list of IAM policies to be pushed to a governing tenancy and a list of IAM policies to be pushed to one or more subject tenancies if there is a successful handshake associated with the governing service. For example, if a governing tenancy manages security for a subject tenancy using a particular security service, a handshake between the tenancies should occur. If the handshake is successful, then the cloud service provider pushes policies to the tenancies to ensure that the security service can perform necessary operations corresponding to the tenancies. A set of IAM policies is created for the governing tenancy, and a separate set of policies is created for the subject tenancies in an embodiment. In an embodiment, policies may not need to be pushed to the tenancies.

In accordance with one or more embodiments, the process of onboarding a new governing service to be made available to governing tenancies for performing actions corresponding to subject tenancies includes the new governing service sending an onboarding request that includes one or more of the following: a governing service name, a feature name, a description of the governing service, and a URL that links to governing service documentation. When a feature name is provided, that feature may be offered separately from other features of the new governing service. For example, if the governing service being onboarded is a security service, it may include several distinct features, such as threat detection, automated remediation, instance security, and others. A separate onboarding process may be used for each separate feature, or the security service may be onboarded without specifying features if features are to be used.

In accordance with one or more embodiments, a modular governance framework enables services to have independently defined governance rules and policies. A modular framework allows developers to build applications by assembling independent modules. This makes it easy to add, remove, or update services without affecting the entire system and other services, enabling better scalability. In a typical cloud governance solution, governance features are often rigidly defined, controlled by the platform provider, and fail to provide the flexibility on a per-service basis. However, in an embodiment implementing a modular governance framework, each governing service may be associated with policies and rules that are different from one another if desired.

In accordance with one or more embodiments, developers or administrators of each governing service may leverage the flexibility of this modular governance framework to enable fine-tuned control over governing service to adjust the behavior of individual governing services without affecting the entire system. Developers and administrators may also benefit from the distributed maintenance that comes with modularity. For example, if a particular governing service is updated, the policies and rules associated with the update are limited to use with that particular service, and do not impact other governing services. In addition, since governing services are independent, fixing bugs becomes easier due to the ability to isolate behaviors within a particular governing service.

In an embodiment, if the cloud provider is also the provider of the governing service being onboarded, the governing service introduces a distinct resource principal type that is tailored for governance actions linked to the governing service name. If the cloud provider is not the provider of the governing service, additional steps will be taken to assign a distinct resource principal type. The resource principal type is registered with the intermediary and is used to onboard the governing service tenancy to the new resource principal type and to issue resource principal tokens on behalf of the onboarding governing service. Once a governing service has been onboarded with the intermediary, users or resources associated with the governing tenancy may make a request to the governing service that initiates an advanced governance workflow designed to ensure that the governing service can perform operations within subject tenancies on behalf of the governing tenancy (including users and resources associated with the governing tenancy).

FIG. 7 illustrates an example set of operations for the creation and use of governance links in accordance with one or more embodiments. One or more operations illustrated in FIG. 7 may be modified, rearranged, or omitted. Accordingly, the particular sequence of operations illustrated in FIG. 7 should not be construed as limiting the scope of one or more embodiments.

In accordance with one or more embodiments, an invitation request originating from the governing tenancy is sent to a governing service such as a security service (Operation 705). The invitation request may be made directly or indirectly to the governing service using any method of communication supported by the governing service. For example, the invitation request may be made within a GUI, command line interface, or API associated with the governing service. The invitation request is a request to initiate governance of one or more subject tenancies using the governing service or specific features of the governing service through a handshake process that requires both an invitation and acceptance of the invitation.

In an embodiment, a user associated with the governing tenancy may log into a user interface associated with a security service and make an explicit request for the security service to perform, on behalf of the governing tenancy, security-related operations corresponding to one or more subject tenancies. This is interpreted as an invitation request because a handshake is required for the governing service to initiate governance operations. As an example, the operations may be to execute applications, collect access data, inspect log files, or configure a governing service or application assigned to the subject tenancy(ies).

In accordance with one or more embodiments, the governing service sends an invitation creation request to the intermediary (Operation 710). The invitation creation request includes instructions for the intermediary to send an invitation to one or more subject tenancies. Although the initial invitation request was initiated at the governing service by a user or resource associated with the governing tenancy, it is the governing service that sends the invitation creation request to the intermediary on behalf of the governing tenancy. The invitation creation request includes a governing service name attribute that indicates the name of the governing service that will be approved for performing operations corresponding to the subject tenancy. In an embodiment, a feature name attribute may be included, indicating the name of a feature associated with the governing service that will be approved for performing operations corresponding to the subject tenancy. An empty governing service attribute is not allowed in one or more embodiments.

In accordance with one or more embodiments, the intermediary sends an invitation to a subject tenancy (Operation 715). The intermediary facilitates the handshake process between the governing service acting on behalf of the governing tenancy and the subject tenancy. In an embodiment, the intermediary sends the invitation to more than one subject tenancy. For example, if a governing tenancy is associated with more than one subject tenancy, the intermediary may be configured to send the invitation to subject tenancies associated with the governing tenancy. To determine the subject tenancies that are associated with the governing tenancy, the intermediary may access and inspect subscription or organization information. For example, if a governing tenancy is associated with a particular subscription, subject tenancies that are associated with the same particular subscription or organization may be sent the invitation by the intermediary. This is because a relationship is inferred based on the shared subscription.

In accordance with one or more embodiments, if a governing service acting on behalf of a governing tenancy requests that an invitation be sent to a subject tenancy that does not share a subscription with the governing tenancy, an additional handshake takes place. The intermediary determines or infers, from subject tenancy's subscription, a tenancy (administrative tenancy) that is authorized to approve or deny the request. In other words, even if the subject tenancy responds affirmatively to the invitation, the authorized tenancy may deny the request, resulting in a denial of link creation between the governing tenancy and the subject tenancy. In accordance with one or more embodiments, the intermediary can send an administrative invitation to a resource associated with the administrative tenancy. The administrative invitation is a request to allow the subject tenancy to be subject to control by the governing tenancy with respect to operations performed by the governing service. A governance link may be created once acceptance is received from a resource associated with the administrative tenancy.

In accordance with one or more embodiments, the intermediary can send the invitation to a subject tenancy using a variety of communication methods. For example, the invitation may be sent via a GUI, a command line interface, and/or a shared communication tool, such as a chat room, email, or other mechanism.

In accordance with one or more embodiments, a subject tenancy accepts the invitation (Operation 720). The acceptance may be performed by an administrative user associated with the subject tenancy, the acceptance being attributed to the subject tenancy. The acceptance may be communicated using the same channel used by the governing service for sending the invitation. In an embodiment, a different communication channel may be used. For example, a hyperlink for indicating acceptance may be emailed to a user associated with the subject tenancy with selecting the link being the expected mechanism for indicating acceptance. In such a case, email is the communication channel for the invitation, while a hyperlink selection is the communication channel for acceptance.

In accordance with one or more embodiments, once the invitation is accepted, the intermediary pushes out IAM policies that were created for the subject tenancy. In an embodiment, the intermediary pushes out IAM policies that were created for the governing tenancy when the intermediary receives the request from the governing service at operation 715. These policies are the policies provided by the governing service provider that are needed to enable the use of the resource principal associated with the governing service to perform operations corresponding to the subject tenancy. For example, the IAM policies pushed to the governing tenancy and subject tenancies have the settings and permissions to allow the governing service to securely govern the subject tenancy on behalf of the governing tenancy with respect to the features accepted via the invitation handshake process. Governing services will expect certain IAM policies to exist in the subject tenancy to enable the governing services to perform specific API calls against subject tenancy.

In accordance with one or more embodiments, once the invitation has been accepted by the subject tenancy, a governance link is created and stored in a database or other data storage mechanism. A governance link includes references to the governing tenancy, the subject tenancy, and the governing service associated with the governance link. In an embodiment, a governance link includes one or more features of the governing service, restricting the governing service to use of the features identified in the link. In an embodiment, a governing service may be associated with a governance link that identifies a feature. When a new onboarding request is made to onboard a different feature associated with the governing service, and that feature is not associated with the governance link for that governing service, a reference to the feature is appended to the feature attribute in the governance link for that governing service.

In accordance with one or more embodiments, governance links may identify tenancies, governing services, features of governing services, and other attributes using identifiers. The identifiers may be names, references, or other types of identifiers as long as the intermediary is configured to interpret the identifier as a reference to the correct tenancies, governing services, features of governing services, and other attributes intended to be identified in the governance link. Governing links are associated with a governing link identifier that is unique to the intermediary. A governing link identifier may be used for the intermediary to validate the existence of the link.

In accordance with one or more embodiments, a governing link is associated with a status identifier. The status identifier may be appended to a governing link or may be stored with a reference to the associated governing link. For example, a status table in a database may be used to store a mapping between governance links and a status, referencing the governance links by governance link identifier. The status identifier indicates if the governance link is active, deleting, or deleted. When a governance link is in an active state, the intermediary will honor requests that rely on the governance link, such as requests by the governing service associated with the governing link for a resource principal token that will form the basis for authorization for the governing service to perform operations corresponding to a subject tenancy.

In accordance with one or more embodiments, the intermediary notifies the governing service of the acceptance of the invitation (Operation 725). In an embodiment, the intermediary notification is sent after the governance link has been created. The notification includes an indication of acceptance and a governance link identifier corresponding to the request.

In accordance with one or more embodiments, a request originating from the governing tenancy is sent to a governing service (Operation 730). For example, a user associated with the governing tenancy that is logged in to a user interface for the governing service may upload a configuration for the governing service to be pushed out to one or more subject tenancies. The governing service may be a security service, for example, and the configuration may be an access control list or other security configuration to be implemented by the governing service across the one or more subject tenancies.

In accordance with one or more embodiments, the governing service sends a request for a resource principal token to the intermediary (Operation 735). The request includes a resource principal, a governance link identifier, and a service name or reference. In an embodiment, the request also includes a reference to one or more features of the governing service. The intermediary validates the request to verify the authenticity of the resource principal and the validity of the governance link that is referenced in the request. To validate the governance link, the intermediary uses the governance link identifier to look up the associated governance link.

In accordance with one or more embodiments, the intermediary returns a resource principal token to the governing service (Operation 740). If the governance link is in an active state and corresponds to the governing service requesting a resource principal token, the governance link will be considered valid, and the resource principal token will be provided to the governing service. If the governance link is in a deleted state, no resource principal token will be provided to the governing service in response to the request.

In an embodiment, if the governance link is in a deleting state and corresponds to the governing service requesting a resource principal token, the governance link will be considered valid, and the resource principal token will be provided to the governing service. A governance link will be placed in a deleting state if a request is made by either the governing tenancy or the subject tenancy to terminate the governance link. This special case allows a governing service to perform “clean-up” operations within the subject tenancy. For example, if the governing service is a security service that has installed applications within the tenancy, the governing service may remove the installed applications if the governance link is in the process of being severed. In such cases, the governing service will send a follow-up request to place the governance link in deleted status after the clean-up operations are complete.

In accordance with one or more embodiments, governing services may subscribe to one or more event streams. The intermediary may publish events to the event stream, including events that indicate a status change of a governing link from an active state to a deleting or deleted state. Other events, including those related to creating governance links, accepting invitations, and appending features to governing links, may be published to the event stream for consumption by governing services. Events may also be published to a log that is accessible by governing services and may be communicated directly to governing services via an API or other mechanism in an embodiment.

In accordance with one or more embodiments, the governing service converts the resource principal token to a resource principal session token by interacting with an identity and access management system. A service with a resource principal token converts the resource principal token to a resource principal session token to gain access to other cloud infrastructure resources. This conversion process involves using the resource principal token to authenticate with a resource principal session endpoint. The endpoint verifies the validity and integrity of the RPT. Upon successful validation, the system generates a resource principal session token. The resource principal session token may be a JSON web token, refresh token, or any other token with the attributes described herein. The resource principal session token includes a session context and permissions specific to the session in an embodiment. This session context defines the scope and duration specifying when the service can access the requested resources.

In accordance with one or more embodiments, the resource principal session token is returned to the governing service and includes this token in requests when accessing associated resources. The receiving resource verifies the resource principal session token, ensuring the requesting service has the necessary permissions to perform the requested actions. This mechanism ensures that the service's access is restricted to the resources and operations defined in the resource principal session token.

In accordance with one or more embodiments, the governing service performs an operation on the subject tenancy using the resource principal session token (Operation 745). The operation may be performed by making a request to an API, by invoking functions, or interacting with other resources. Once a resource principal session token expires, a new resource principal session token will be obtained when further operations are necessary, assuming the governance link is still active. In an embodiment, the subject tenancy determines the scope of allowed operations corresponding to the subject tenancy that may be performed by the first service on behalf of the governing tenancy. This is based at least in part on the set of IAM policies pushed to the subject tenancy at the time of the creation of the governance link.

### 6. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims. FIG. 8 illustrates an example set of operations for the use of governance links in accordance with one or more embodiments.

In accordance with one or more embodiments, an intermediary receives a request for a resource principal token from a governing service, the request comprising a resource principal, a governing service identifier that identifies the governing service, and a link identifier that identifies a governance link associated with a governing tenancy and a subject tenancy (Operation 801). In an embodiment, the request also includes a reference to one or more features of the governing service.

In accordance with one or more embodiments, the intermediary evaluates the governance link to determine if the governance link is active (Operation 802). The intermediary validates the request to verify the authenticity of the resource principal and the validity of the governance link that is referenced in the request. To validate the governance link, the intermediary uses the governance link identifier to look up the associated governance link. In accordance with one or more embodiments, the intermediary determines that the governance link is active (Operation 803).

In accordance with one or more embodiments, the intermediary responds to the request with a resource principal token (Operation 804). If the governance link is in an active state and corresponds to the governing service requesting a resource principal token, the governance link will be considered valid, and the resource principal token will be provided to the governing service. If the governance link is in a deleted state, no resource principal token will be provided to the governing service in response to the request.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
receiving, from a first service, a first request for a resource principal token;
wherein the first request comprises:
a resource principal;
a first service identifier that identifies the first service; and
a link identifier that identifies a first governance link associated with a governing tenancy and a subject tenancy;
evaluating the first governance link to determine if the first governance link is active; and
in response, at least in part, to determining that the first governance link is active, responding to the first service with a first resource principal token, wherein the first resource principal token forms a basis for authorizing the first service to perform operations corresponding to the subject tenancy on behalf of the governing tenancy.

2. The non-transitory computer readable media of claim 1, wherein the governance link comprises:
a parent identifier associated with the governing tenancy;
a child identifier associated with the subject tenancy;
a feature identifier;
a status indicator that indicates if the link is active; and
a second service identifier that identifies the first service.

3. The non-transitory computer readable media of claim 2, wherein the step of responding to the first service with a first resource principal token is performed in response, at least in part, to:
validating the first service based at least in part on the resource principal; and
determining that the first service identifier matches the second service identifier.

4. The non-transitory computer readable media of claim 1, wherein the request further comprises a feature identifier that identifies a feature associated with the first service, and the governance link further comprises the feature identifier.

5. The non-transitory computer readable media of claim 1, wherein the operations further comprise:
receiving a second request, wherein the second request is a request to terminate the governance link;
placing the governance link in deleting status by updating the status identifier to indicate that the governance link is in deleting status;
indicating to the first service that the governance link has been placed in deleting status by one or more of:
adding event information to an event stream associated with events related to governance links, wherein the event information indicates the status change associated with the first service; or
responding to a request for updated information from the first service with information indicates the status change associated with the first service.

6. The non-transitory computer readable media of claim 5, wherein the operations further comprise:
receiving a third request, wherein the third request is a request from the first service for a resource principal token;
wherein the first request comprises:
a resource principal;
the first service; and
the link identifier that identifies the first governance link;
evaluating the first governance link to determine if the first governance link is active;
in response, at least in part, to determining that the first governance link is in deleting status, responding to the first service with a second resource principal token, wherein the second resource principal token forms a basis for authorizing the first service to perform operations corresponding to the subject tenancy on behalf of the governing tenancy;
receiving a fourth request, wherein the fourth request is a request from the first service to place the governance link into deleted status; and
in response to the fourth request, placing the governance link into deleted status by updating the status identifier to indicate that the governance link is in deleted status.

7. The non-transitory computer readable media of claim 6, wherein the operations further comprise:
the first service using the second resource principal token to obtain access to resources corresponding to the subject tenancy;
performing, by the first service, operations corresponding to the subject tenancy; and
wherein the operations are restricted by to operations related to service removal based at least in part on determining that the governance link is in deleting status.

8. The non-transitory computer readable media of claim 1, wherein the operations further comprise, prior to receiving the first request:
receiving a first invitation instruction from the first service, wherein the first invitation instruction is based on a first invitation request originating from the governing tenancy;
sending a first link invitation to a resource associated with the subject tenancy, wherein the first link invitation comprises a request to allow the subject tenancy to be subject to control by the governing tenancy with respect to operations performed by the first service;
receiving a first invitation acceptance from a resource associated with the subject tenancy; and
in response to receiving the first invitation acceptance, forming the first governance link.

9. The non-transitory computer readable media of claim 8, wherein the operations further comprise, prior to receiving the first request, confirming to the first service that the link invitation is accepted.

10. The non-transitory computer readable media of claim 8, wherein the operations further comprise, prior to receiving the first request:
in response at least in part to receiving the first invitation acceptance, pushing a set of IAM policies associated with the first service to the governing tenancy.

11. The non-transitory computer readable media of claim 10, wherein the operations further comprise:
receiving a second invitation instruction from a second service, wherein the second invitation instruction is based on a second invitation request originating from the governing tenancy;
sending a second link invitation to a resource associated with the subject tenancy, wherein the second link invitation comprises a request to allow the subject tenancy to be subject to control by the governing tenancy with respect to operations performed by the second service;
receiving a second invitation acceptance from a resource associated with the subject tenancy; and
in response to receiving the second invitation acceptance, forming a second governance link;
in response at least in part to receiving the second invitation acceptance, pushing a set of IAM policies associated with the second service to the governing tenancy, wherein the set of IAM policies associated with the second service is different than the set of IAM policies associated with the first service.

12. The non-transitory computer readable media of claim 8, wherein the operations further comprise, prior to receiving the first request:
in response at least in part to receiving the first invitation acceptance, pushing a set of IAM policies associated with the service to the subject tenancy.

13. The non-transitory computer readable media of claim 12, wherein the operations further comprise:
determining, based at least in part on the set of IAM policies, the scope of allowed operations corresponding to the subject tenancy that may be performed by the first service on behalf of the governing tenancy.

14. The non-transitory computer readable media of claim 8, wherein:
the first invitation instruction comprises:
a reference to the governing tenancy;
a reference to the subject tenancy;
a reference to the first service;
a reference to a first feature associated with the first service; and
the governance link further comprises a first feature identifier that identifies the first feature.

15. The non-transitory computer readable media of claim 14, wherein the operations further comprise:
receiving a second invitation instruction from the first service, wherein the second invitation instruction comprises:
a reference to the governing tenancy;
a reference to the subject tenancy;
a reference to the first service;
a reference to a second feature associated with the first service;
sending a second link invitation to a resource associated with the subject tenancy, wherein the second link invitation indicates a request to allow the subject tenancy to be subject to control by the governing tenancy with respect to operations corresponding to the second feature that are performed by the first service;
receiving a second invitation acceptance from a resource associated with the subject tenancy; and
in response to receiving the second invitation acceptance, updating the governance link to further comprise a second feature identifier that identifies the second feature.

16. The non-transitory computer readable media of claim 14, wherein the operations further comprise:
receiving a second invitation instruction from the first service, wherein the second invitation instruction comprises:
a reference to the governing tenancy;
a reference to the subject tenancy;
a reference to the first service;
a reference to a second feature associated with the first service;
sending a second link invitation to a resource associated with the subject tenancy, wherein the second link invitation indicates a request to allow the subject tenancy to be subject to control by the governing tenancy with respect to operations corresponding to the second feature that are performed by the first service;
receiving a second invitation acceptance from a resource associated with the subject tenancy; and
in response to receiving the second invitation acceptance, forming a second governance link.

17. The non-transitory computer readable media of claim 8, wherein the operations further comprise:
identifying a plurality of subject tenancies associated with the governing tenancy; and
sending a link invitation to each subject tenancy of the plurality of subject tenancies.

18. The non-transitory computer readable media of claim 8, wherein the operations further comprise:
accessing subscription information to determine if the governing tenancy and the subject tenancy are associated with the same subscription-sharing organization; and
wherein the step of forming the first governance link is performed in response, at least in part, to determining that the governing tenancy and the subject tenancy are associated with the same subscription-sharing organization.

19. The non-transitory computer readable media of claim 8, wherein the operations further comprise:
accessing subscription information to determine if the governing tenancy and the subject tenancy are associated with the same subscription-sharing organization;
determining that the governing tenancy and the subject tenancy are associated with the same subscription-sharing organization;
accessing subscription information to identify an administrative tenancy associated with the same subscription-sharing organization as the governing tenancy;
sending an administrative invitation to a resource associated with the administrative tenancy, wherein the administrative invitation comprises a request to allow the subject tenancy to be subject to control by the governing tenancy with respect to operations performed by the first service;
receiving an administrative acceptance from a resource associated with the administrative tenancy; and
wherein the step of forming the first governance link is performed in response, at least in part, to receiving the administrative acceptance.

20. A system, comprising:
at least one device including a hardware processor;
the system being configured to perform operations comprising:
receiving, from a first service, a first request for a resource principal token;
wherein the first request comprises:
a resource principal;
a first service identifier that identifies the first service; and
a link identifier that identifies a first governance link associated with a governing tenancy and a subject tenancy;
evaluating the first governance link to determine if the first governance link is active; and
in response, at least in part, to determining that the first governance link is active, responding to the first service with a first resource principal token, wherein the first resource principal token forms a basis for authorizing the first service to perform operations corresponding to the subject tenancy on behalf of the governing tenancy.

21. A method, comprising:
receiving, from a first service, a first request for a resource principal token;
wherein the first request comprises:
a resource principal;
a first service identifier that identifies the first service; and
a link identifier that identifies a first governance link associated with a governing tenancy and a subject tenancy;
evaluating the first governance link to determine if the first governance link is active;
in response, at least in part, to determining that the first governance link is active, responding to the first service with a first resource principal token, wherein the first resource principal token forms a basis for authorizing the first service to perform operations corresponding to the subject tenancy on behalf of the governing tenancy; and
wherein the method is performed by at least one device including a hardware processor.
